(19) United States
(12) Patent Application Publication
(10) Pub. No.: US 2012/0251776 A1
(43) Pub. Date: Oct. 4, 2012

(54) Method of Treating a Layer of Material and the Product Formed by the Method

(75) Inventors: Stuart Paul GODFREY, Farnborough (GB); Caroline Elizabeth MILLAR, Bramley (GB)

(73) Assignee: Nokia Corporation

(21) Appl. No.: 13/073,363

(22) Filed: Mar. 28, 2011

(51) Int. Cl. B32B 3/00; B32B 37/10; B32B 38/10; B32B 5/02

(52) U.S. Cl. 428/142; 428/141; 442/152; 156/286; 156/247

(57) ABSTRACT

An apparatus including a layer of natural, textured material including a first side and a second side; and cured adhesive impregnated into the layer of natural, textured material from the first side but not from the second side.

### TECHNOLOGICAL FIELD

Embodiments of the present invention relate to a method of treating a layer of material and the product formed by the method. In particular, some embodiments relate to a method of treating a layer of snake skin to increase its range of applications.

### BACKGROUND

It is possible to use natural animal products to accessorize electronic or mechanical devices. For example, a leather strap may be used for a watch.

It is also possible to use natural animal products to create accoutrements. For example, leather may be used to create shoes and hang-bags.

Not all natural animal products are as pliable and as robust as leather. This limits their range of applications

It would be desirable to treat a layer of natural material so that it has a greater range of applications.

### BRIEF SUMMARY

According to various, but not necessarily all, embodiments of the invention there is provided an apparatus comprising: a layer of natural, textured material comprising a first side and a second side; and cured adhesive impregnated into the layer of natural, textured material from the first side but not from the second side.

According to various, but not necessarily all, embodiments of the invention there is provided a method comprising: forming a stack comprising a substrate, adhesive, a layer of natural, textured material and a cover membrane; removing atmosphere from between the layer of material and the cover membrane to draw the cover membrane onto the layer of material and to impregnate the layer of material with adhesive; and curing the adhesive.

According to various, but not necessarily all, embodiments of the invention there is provided an apparatus comprising: a layer of material comprising a first side and a second side; and cured adhesive impregnated into the layer of material from the first side.

### BRIEF DESCRIPTION

For a better understanding of various examples of embodiments of the present invention reference will now be made by way of example only to the accompanying drawings in which:

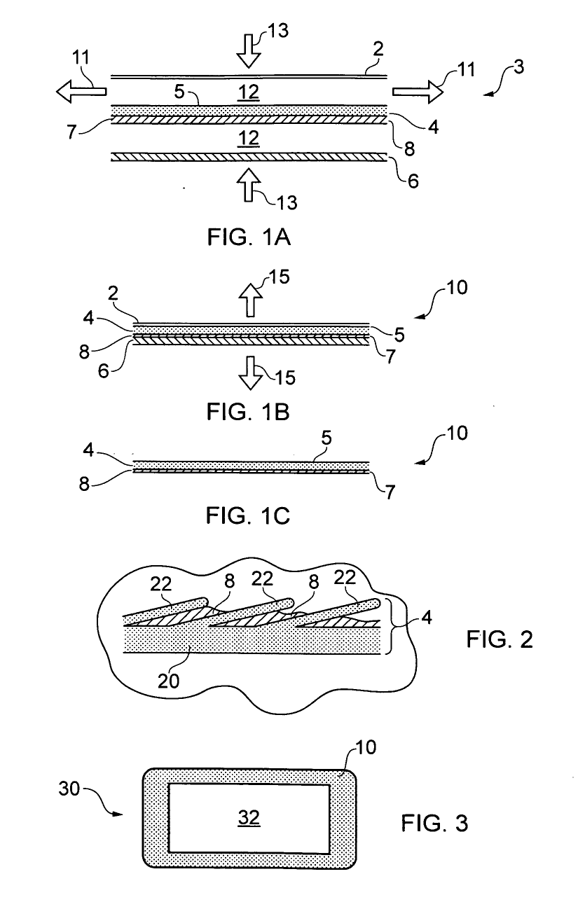

FIG. 1A illustrates a stack comprising a substrate, adhesive, a layer of material and a cover membrane;

FIG. 1B illustrates a thin, flexible laminate structure formed from the stack by evacuating an atmosphere within the stack;

FIG. 1C illustrates a structure formed from the stack by removing the cover membrane and the substrate;

FIG. 2 illustrates a thin, flexible structure formed from the stack by evacuating an atmosphere within the stack and then removing the cover membrane and the substrate, when the layer of material is snake skin; and

FIG. 3 illustrates the use of the flexible structure as a covering for an electronic device.

### DETAILED DESCRIPTION

The figures illustrate an apparatus 10 comprising a layer of natural, textured material 4 comprising an upper surface 5 and a lower surface 7; and cured adhesive 8 impregnated into the layer of natural, textured material 4 from the lower surface 7 but not from the upper surface 5.

A method of manufacturing the apparatus 10 is illustrated in FIGS. 1A, 1B and 1C.

Some embodiments of the invention mitigate the problem of scale lifting which occurs when a snake skin is contorted because the scales are attached to the underlying epidermis at one end and not the other. When the skin is contorted, the scales can therefore pivot causing the non attached edge of the scale to lift. This scale lifting causes a rough feel (which can get worse with time) and also allows moisture to enter and cause degradation. In some embodiments of the invention, when the skin is contorted, the scales are fixed and do not lift. Some embodiments of the invention stick down the snake scales efficiently and consistently allowing snake skins to be used on curved complex surfaces without the scales lifting. Some embodiments of the invention enable the use of snake skin, such as Python skin for example, in applications whether the skin is contorted.

In FIG. 1A, a stack 3 is formed comprising a substrate 6, adhesive 8, a layer of material 4 and a cover membrane 2.

An atmosphere 12 which may be air or some other inert gas is present between at least the cover membrane 2 and an upper surface 5 of the layer of material 4. The atmosphere 12 may also be present between a lower surface 7 of the layer of material 4 and the substrate 6. The adhesive 8 may be formed as a layer on the lower surface 7 of the layer of material 4 and, in this example (as illustrated), an atmosphere 12 may be present between the adhesive layer 8 and the substrate 6.

The atmosphere 12 is then removed 11 from the stack 3 by evacuation. The cover membrane 2 and the substrate 6 are typically impermeable to the atmosphere. Consequently, removing the atmosphere 12 creates a lower pressure region between the cover membrane 2 and the layer of material 4 and, optionally, also between the layer of material 4 and the substrate 6.

The lower pressure region between the cover membrane 2 and the layer of material 4 draws the adhesive 8 into the layer of material 4 impregnating it. The lower pressure region between the cover membrane 2 and the layer of material 4 draws the cover membrane 2 towards the upper surface 5 of the layer of material 4 protecting it from adhesive 8 and presenting a barrier to the further impregnation of adhesive 8. When the adhesive cures a thin laminate structure results as illustrated in FIG. 1B.

The FIG. 1B illustrate an apparatus 10 comprising a layer material 4 comprising an upper surface 5 and a lower surface 7; and cured adhesive 8 impregnated into the layer of material 4 from the lower surface 7 but not from the upper surface 5. The apparatus 10 additionally comprises the cover membrane 2 and the substrate 6.

In some embodiments, the laminate structure 10 illustrated in FIG. 1B is a final product. In other embodiments, the laminate structure illustrated in FIG. 1B is an intermediate product and the cover membrane 2 and/or the substrate 6 is/are removed 15 to form a final product.

In the laminate structure 10 illustrated in FIG. 1B, a flexible layer of material 4 is supported by a substrate 6 and is covered by a flexible cover membrane 2. Impregnating the layer of material 4 with adhesive strengthens the material 4. The adhesive is preferably fluid or gel before curing so that it impregnates the layer of material 4. It is also possible for the adhesive cured state to be transparent. It may also or alternatively be flexible.

The adhesive is chosen so that it has the correct curing properties and correct viscosity. If the glue dries too quickly then it will not infuse through the material 4, similarly if the glue is too viscous then it will not penetrate through the layer of material 4.

The cover membrane 2 is pliable and conforms to any relief on the upper surface 5 of the layer of material 4. The cover membrane 2 may be for example a thin, pliable sheet. It may be formed from a polymer plastic, for example.

Referring to the laminate structure 10 illustrated in FIG. 1B, the cover membrane 2 closely follows any contours of an upper surface 5 of the layer of material 4. There may be little or no air gap between the cover membrane 2 and the layer of material 4. Texture represented by the contours of the upper surface 5 of the layer of material may, as a result, also be present in the laminate structure 10, represented by contours in an upper surface of the flexible cover membrane 2 after forming the laminate structure 10.

The layer of material 4 may be a layer of natural material such as animal skin (leather) or fabric. The material 4 may be textured, with the texture being represented by contours in an upper surface of the flexible cover membrane 2 of the laminate structure 10.

Where the laminate structure 10 illustrated in FIG. 1B is a final product, the substrate 6 may be flexible so that the laminate structure 10 is flexible. The cover membrane 2 may also be transparent so that the coloration of the layer of material 4 is visible through the cover membrane 4. The cover membrane 2 protects the layer of material 4 from physical damage.

Where the laminate structure 10 illustrated in FIG. 1B is an intermediate product, the substrate 6 may or may not be flexible. The cover membrane 2 may or may not be transparent. The cover membrane 2 may temporarily protect the upper surface 5 of the layer of material 4 from the adhesive 8.

FIG. 1C illustrates the apparatus 10 after both the cover membrane 2 and the substrate 6 have been removed. FIG. 10 illustrates an apparatus 10 comprising a layer of material 4 comprising an upper surface 5 and a lower surface 7; and cured adhesive 8 impregnated into the layer of material 4 from the lower surface 7 but not from the upper surface 5.

In some embodiments, a vacuum bagging process may be used. In these embodiments, the cover membrane 2 and the substrate 6 may be provided by upper and lower portions of a vacuum bag. The layer of material 4 that has adhesive 8 formed as a layer on the lower surface 7 of the layer of material 4, is placed in a vacuum bag and the atmosphere is evacuated from the bag (FIG. 1A). The adhesive is cured (FIG. 1B). The apparatus 10 is then removed from the vacuum bag 2, 6 (FIG. 1C).

However in some embodiments, the layer of material 4 is coated with adhesive 8 on the lower surface 7 of the layer of material 4. The coated layer of material is then placed between two sheets of release paper and placed on a support surface. A flexible sheet is placed over the stack formed from the bottom up by the lower release paper, adhesive 8, material 4, upper release paper to enclose a sealed atmosphere around the stack. The sealed atmosphere is then evacuated (FIG. 1A). The adhesive 8 is then cured (FIG. 1B). The stack is then converted to the apparatus 10 (FIG. 10) by removing the lower release paper from the lower surface 7 of the layer of material 4 and by removing the upper release paper from the upper surface 5 of the layer of material 4. In this example, the cover membrane 2 can be considered to be the flexible sheet or the combination of flexible sheet and upper release paper. In this example, the substrate 6 can be considered to be the support surface or the combination of support surface and lower release paper.

In one embodiment, illustrated in FIG. 2, the layer of material 4 is scaled animal skin. The layer of material comprises a lower layer (epidermis) 20 which is connected to scales 22. In this example, the animal skin is a snake skin (e.g. python skin) and the scales 22 are attached to the epidermis 20 at one end only with the other end being unconnected. The scales are consequently pivotally connected to the epidermis 20. In the absence of the cured adhesive 8, the scales 22 would pivot when the scaled animal skin 4 is flexed. The adhesive 8 has been drawn through the epidermis 20 of the snake skin into voids between the scales 22. The adhesive adheres a scale 22 to an adjacent scale and the epidermis 20 preventing it moving independently and preventing lift of the scales 22 when the epidermis 20 is contorted.

In other embodiments, the layer of material 4 may be a fabric such as silk.

As illustrated in FIG. 3, the apparatus 10 (flexible structure) may be used for covering an electronic device 30 such as the mobile electronic device illustrated. In this example the electronic device 30 comprises a display 32 that is not covered by the flexible structure 10 and a housing that is at least partially covered by the flexible structure 10 with the cover membrane 2 outermost. The apparatus 10 is able to contort to bend around edges and/or corners without damaging the layer of material 4.

The flexible laminate structure 10 formed as the direct product of the method illustrated in FIGS. 1A and 1B, may therefore be used as a cover for a mobile device 30.

The flexible laminate structure 10, formed as the direct product of the method illustrated in FIGS. 1A and 1B, may alternatively be used as part of an accoutrement such as, for example, personal clothing, accessories, watch straps, bags, shoes etc.

The flexible structure 10, formed as the direct product of the method illustrated in FIGS. 1A, 1B and 1C, may therefore be used as a cover for a mobile device 30.

The flexible structure 10, formed as the direct product of the method illustrated in FIGS. 1A, 1B and 1C, may alternatively be used as part of an accoutrement such as, for example, personal clothing, accessories, watch straps, bags, shoes etc.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a layer of natural, textured material comprising a first side and a second side; and
cured adhesive impregnated into the layer of natural, textured material from the first side but not from the second side.

2. An apparatus as claimed in claim 1, wherein the layer of material is animal skin and wherein the first side is an interior side of the animal skin and the second side is an exterior side of the animal skin.

3. An apparatus as claimed in claim 2, wherein the layer of material is scaled animal skin.

4. An apparatus as claimed in claim 3, wherein the scaled animal skin comprises scales which in the absence of the cured adhesive would pivot when the scaled animal skin is flexed.

5. An apparatus as claimed in claim 4, wherein the layer of material is snake skin.

6. An apparatus as claimed in claim 5, wherein the snake skin is python skin.

7. An apparatus as claimed in claim 1, wherein the layer of natural, textured material is a natural fabric.

8. An apparatus as claimed in claim 1, further comprising a cover membrane over the layer of natural, textured material.

9. (canceled)

10. An apparatus as claimed in claim 8, wherein the cover membrane is transparent.

11. An apparatus as claimed in claim 8, further comprising a substrate under the layer of natural, textured material, wherein cured resin is between the substrate and the first side of the layer of natural, textured material.

12. (canceled)

13. An apparatus as claimed in claim 1, forming a covering for a mobile device or an accouterment.

14. (canceled)

15. (canceled)

16. A method comprising:
forming a stack comprising a substrate, adhesive, a layer of natural, textured material and a cover membrane;
removing atmosphere from between the layer of material and the cover membrane to draw the cover membrane onto the layer of material and to impregnate the layer of material with adhesive; and
curing the adhesive.

17. A method as claimed in claim 16, further comprising removing the cover membrane.

18. A method as claimed in claim 16, further comprising removing the substrate.

19. A method as claimed in claim 16, wherein the layer of material is animal skin.

20. A method as claimed in claim 16, wherein the layer of material is scaled animal skin.

21. A method as claimed in claim 20, wherein the scaled animal skin comprises scales which in the absence of the cured adhesive would pivot when the scaled animal skin is flexed and wherein impregnating the layer of natural, textured material squeezes adhesive through the scaled animal skin such that scales of the scaled animal skin are adhered, after curing the adhesive, to prevent lift when the snake skin is contorted.

22. A method as claimed in claim 16, wherein the layer of material is snake skin.

23. (canceled)

24. A method as claimed in claim 16, further comprising removing the cover membrane; and
removing the substrate,
to produce, as a direct product, a piece suitable for use as a cover for an electronic device or as an accoutrement.

25. An apparatus comprising:
a layer of material comprising a first side and a second side; and
cured adhesive impregnated into the layer of natural, textured material from the first side.
